(19) United States
(12) Patent Application Publication
(10) Pub. No.: US 2010/0316219 A1
(43) Pub. Date: Dec. 16, 2010

(54) Systems and methods for simultaneous integrated multiencrypted rotating key communication

(76) Inventors: David Boubion, Tampa, FL (US); Peter Rung, Lutz, FL (US); Mary Claire Ryan, Burr Ridge, IL (US)

Correspondence Address: SCHERRER PATENT & TRADEMARK LAW P.C., 17 E. CRYSTAL LAKE AVE, CRYSTAL LAKE, IL, 60014, US

(21) Appl. No.: 12/657,497

(22) Filed: Jan. 21, 2010

Related U.S. Application Data
(63) Continuation-in-part of application No. 11/890,427, filed on Aug. 6, 2007.
(60) Provisional application No. 61/146,297, filed on Jan. 21, 2009.

(51) Int. Cl. H04L 9/14

(52) U.S. Cl. 380/259

(57) ABSTRACT

Systems and methods are provided for manual and/or automatic initiation of simultaneous multi-encrypted rotating key communication. Specifically, decryption of data between a first user and one more other users during a communication session may occur using a plurality of keys that rotate or change after an event has occurred, such as an amount of time has elapsed during the communication session or an amount of data has been transmitted during the communication session. The first user and the one or more other users may have a repository for the storage of the plurality of keys to use during the communication session.

The present invention is a continuation-in-part of U.S. patent application Ser. No. 11/890,421, filed Aug. 6, 2007, and further claims priority to U.S. Provisional Patent Application No. 61/146,297, filed Jan. 21, 2009, each of which is expressly incorporated herein in its entirety.

### TECHNICAL FIELD

The present invention relates to systems and methods for conducting secured telephony and transaction authentication via electronic devices. More specifically, the embodiments of the present invention relate to systems and methods for conducting secure networked telephony, including but not limited to communications over the internet, other networks, wired or wireless networks, or audio, video or multi-media. Further, the present invention relates to systems and methods for manual and/or automatic initiation of simultaneous multi-encrypted rotating key communication.

### BACKGROUND

Conventional telephony involves standard packet-switching technology, and this standard packet-switching technology has existed for more than 30 years. However, telephony applications are in the process of expanding into other communications protocols, such as IP/SIP (Internet Protocol Telephony/Session Initiation Protocol) and VoIP (Voice Over Internet Protocol) such as H.323.

These communication protocols include applications such as, but not limited to, encryption ciphers, passwords, tokens, fingerprint biometrics, and secured card/chip technology. By expanding telephony into these relatively new communications protocols, convergence and inter-operability of cryptographic modality is crucial for seamless execution of traffic encryption. However, typical and conventional communication protocols lack efficient cryptographic encryption for secure communication applications for the sending and receiving of data. For example, typical and conventional communication protocols do not provide adequate encryption of packet data, such as encryption of voice, data, text, media and the like. Moreover, typical and conventional communication protocols lack proper cloaking technology for cloaking the presence of vital data and applications at the device or server levels. Security for the transmission of data via networked telephony currently exists, but is typically applied network-wide, and is typically not specifically related to the data being transmitted. A user of networked telephony is typically beholden to the networks for security, which can vary widely from being totally insecure to having some level of security.

A need exists for technological solutions that will provide adequate encryption of packet and IP data for the secure encryption of communication applications, including, but not limited to, voice, data, text, media and other like communication applications. Moreover, a need exists for technological solutions that will provide adequate technology for cloaking or otherwise hiding the presence of vital data at the telephone or server levels in communication applications.

A need further exists for applications that provide and maintain secure communication applications that can be provided to end-users as stand-alone security applications. Moreover, a need exists for applications that provide and maintain secure communication applications that can be provided to operate like private networks to individuals, corporations, government agencies, and other like entities, and to vendor telecom operators as Business-2-Business (B2B) wholesale OEM licensed business models. Still further, a need exists for applications that provide and maintain security on data packet transmission independent of the security, or lack thereof, provided generally to a network.

Still further, a need exists for security applications that can be incorporated into and otherwise be useful with existing telephony infrastructure and with the development of future telephonic applications involving the transmission of data. Specifically, a need exists for a security application that can be a stand-alone application, such as contained on a memory device including, but not limited to, a USB flashdrive, a secure card or chip, or other like memory device that can be utilized by a computer or other electronic device to facilitate security in an electronic communication. Moreover, a need exists for a security application that can be embedded in electronic devices to provide security during electronic communications, including, but not limited to, embedded within a personal digital assistant (PDA), a GSM cellular telephone, dual-phone, radiowave technology, including radios, televisions, or other like electronic devices.

In addition, a need exists for systems and methods that provide automatic or manual rotation of keys for the decryption of encrypted data during a communication session between a first user and one more additional users. Moreover, a need exists for systems and methods providing a repository of a predetermined set of keys for use in automatic or manual key rotation for the decryption of encrypted data during a communication session.

### SUMMARY OF THE INVENTION

The embodiments of the present invention relate to systems and methods for conducting secured communication. More specifically, the embodiments of the present invention relate to systems and methods for conducting secure networked telephony, data, text, audio, video or multimedia communications such as communications over the internet or other networks, whether wired or wireless.

Specifically, the present embodiments relate to the security of communication applications that are embedded at the server level, the network operating center (NOC) level, and with corresponding endpoints, such as, but not limited to, telephones, PDAs, personal computers (PCs), smartcards (i.e. chip card, SD cards, micro SD cards, SIM cards), or standard communication devices, such as radios, televisions, or other like communication devices. The applications serve three distinct functions: 1) to work as physical and logical identified locations for communications; 2) to allow for the transfer of user and security credentials; and 3) to house and embody a true peer-to-peer (P2P) IP telephone security interface. Secure protocols are typically used for key distribution, such as, but not limited to, symmetrical key authentication and asymmetric key authentication, including, but not limited to, Multimedia Internet KEYing (MIKEY) via the Internet Security Association and Key Protocol (ISAKMP).

Moreover, the embodiments of the present invention provide security to any transfer of data packets over any network, regardless of the security, or lack thereof, provided over the network. If security already exists on a network, the embodiments of the present invention provide additional security protection for the transferred data.

To this end, in an embodiment of the present invention, a method of communicating between a first user and a second user is provided. The method comprises the steps of: providing a first user and a second user, the first user and the second user participating in a communication session with each other involving the transmission of data between the first user and the second user, the first user having a first repository having a plurality of keys contained therein, and the second user having a second repository having a plurality of keys contained therein, wherein at least some of the keys in the first repository and the second repository are the same; initiating an encryption of the data between the first user and the second user during the communication session; decrypting the data using a first key, wherein the first key is contained within the first repository and the second repository and the first user and the second user utilize the first key to decrypt the data; decrypting the data using a second key after an event occurs during the communication session, wherein the second key is contained within the first repository and the second repository.

In an embodiment, the event is the end of a time period.

In an embodiment, the event is transmission of an amount of data.

In an embodiment, the utilization of the second key to decrypt the data occurs automatically after the event has occurred.

In an embodiment, the method further comprises the steps of: prior to decrypting the data using the first key, sending a name of the first key from the first user to the second user; querying the second user if the first key is available in the second repository; and proceeding with decrypting the data using the first key if the first key exists in the second repository.

In an embodiment, the method further comprises the step of: decrypting the data using a third key after a subsequent event occurs during the communication session, wherein the third key is contained within the first repository and the second repository.

In an alternate embodiment of the present invention, a method of communicating between a first user and a second user is provided. The method comprises the steps of: providing a communication session between a first user and a second user involving the transmission of encrypted data; decrypting the data at a first time using a first key and decrypting the data at a second time using a second key.

In an embodiment, the first key and the second key are shared between the first user and the second user.

In an embodiment, the first user has a first repository and wherein the first and second keys are stored within the first repository.

In an embodiment, the first user has a first repository wherein the first and second keys are stored within the first repository and the second user has a second repository wherein the first and second keys are stored within the second repository.

In an embodiment, the first user communicates with the second user with a communication application, and further wherein the first user has a first repository wherein the first and second keys are stored within the first repository, and further wherein the first repository is interconnected with the communication application.

In an embodiment, the method further comprises the step of: decrypting the data using different keys after events have occurred during the communication session.

In an embodiment, the decryption of the data occurs after an amount of time has elapsed.

In an embodiment, the decryption of the communication session occurs after an amount of data has been transmitted between the first user and the second user.

In an embodiment, the method further comprises the steps of: providing the communication session between the first user, the second user and a third user, wherein the first user, the second user and the third user have a plurality of the same keys for decrypting the communication session through a process of automatically rotating the keys.

In an alternate embodiment of the present invention, a system for facilitating a secure communication between a first user and a second user is provided. The system comprises: a first user having a communication application for communicating with a second user; a first repository associated with the first user's communication application for storing a plurality of keys; a second user having the communication application for communicating with the first user; and a second repository associated with the second user's communication application for storing the plurality of keys.

In an embodiment, the system further comprises: a communication session between the first user and the second user, wherein the communication session involves the transmission of encrypted data between the first user and the second user; a first key for decrypting the data between the first user and the second user, wherein the first key is stored within the first repository and the second repository; and a second key for decrypting the data between the first user and the second user, wherein the second key is stored within the first repository and the second repository, wherein the first key decrypts the data at a first time and the second key decrypts the data at a second time.

In an embodiment, the system further comprises: a communication session between the first user and the second user, wherein the communication session involves the transmission of encrypted data between the first user and the second user; a first key for decrypting the data between the first user and the second user; and a second key for decrypting the data between the first user and the second user, wherein the first key decrypts the data at a first time and the second key decrypts the data after an event has occurred during the communication session.

In an embodiment, the event is the end of a time period.

In an embodiment, the event is a transmission of an amount of data.

It is, therefore, an advantage of the present invention to provide technological solutions that will provide adequate encryption of packet and IP data for the secure encryption of communication applications, including, but not limited to, voice, data, text, media and other like communication applications. Moreover, a need exists for technological solutions that will provide adequate technology for cloaking or otherwise hiding the presence of vital data at the telephone or server levels in communication applications, and during communication sessions.

Moreover, it is an advantage of the present invention to provide systems and methods to maintain secure communication applications that can be provided to end-users as stand-alone security applications. Moreover, a need exists for applications that provide and maintain secure communication applications that can be provided to operate like private networks to individuals, corporations, government agencies, and other like entities, and to vendor telecom operators as Business-2-Business (B2B) wholesale OEM licensed business models.

Still further, it is an advantage of the present invention to provide systems and methods that provide and maintain security on data packet transmissions independent of the security, or lack thereof, provided generally to a network.

In addition, it is an advantage of the present invention to provide systems and methods for providing security applications that can be incorporated into and otherwise be useful with existing telephony infrastructure and with the development of future communication applications involving the transmission of data. Specifically, a need exists for a security application that can be stand-alone, such as contained on a memory device including, but not limited to, a USB flashdrive, a secure card or chip, or other like memory device that can be utilized by a computer or other electronic device to facilitate security in an electronic communication.

Further, it is an advantage of the present invention to provide systems and methods for providing security applications that can be embedded in electronic devices to provide security during electronic communications, including, but not limited to, embedded with a PDA, a GSM cellular telephone, a dual-phone, radiowave technology, including radios, televisions, or other like electronic devices.

Still further, it is an advantage of the present invention to provide systems and methods that provide automatic or manual rotation of keys for the decryption of encrypted data during a communication session between a first user and one or more other users.

Moreover, it is an advantage of the present invention to provide systems and methods for providing a repository for each user during a communication session of a repository of a predetermined set of a plurality of keys for use in the automatic or manual key rotation for the decryption of encrypted data during a communication session between a first user and one or more other users.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a method of using the security applications of the present invention.

FIG. 2 illustrates a system showing converging telecommunication platforms and applications related thereto of embodiments of the present invention.

FIG. 3 illustrates a preferred symmetrical key generation, distribution and utilization method in an embodiment of the present invention.

FIG. 4 illustrates a method of creating and sharing a plurality of keys for the automatic or manual rotation of keys during a communication session between a first user and a second user in an embodiment of the present invention.

FIG. 5 illustrates a method of conducting a communication session between a first user and a second user utilizing automatic key rotation for the encryption and decryption of data between the first user and the second user in an embodiment of the present invention.

### DETAILED DESCRIPTION OF THE PRESENTLY PREFERRED EMBODIMENTS

The embodiments of the present invention relate to systems and methods for conducting secure telephony. More specifically, the embodiments of the present invention relate to systems and methods for conducting secure electronic communication, such as, but not limited to, networked telephony, including but not limited to communications over the interne or other networks, via one or more security and communications technology platforms whether wired or wireless.

### DEFINITIONS

“Agent” means a program executable on an endpoint or server to execute the preconfigured policy as defined on a server.

“Asymmetric Keys” (“public/private key pair”) means the public and private key pair used by a public key algorithm to authenticate a user's identity.

“Challenge Response Communiqué” means the process of sending a request from the originator (first user) to a recipient (second user) asking if there exists a particular key or set of keys in recipient's repository of keys.

“Communication Event” means a discrete act of communication by sending a set of data from a first user to a second user or a plurality of users, including, but not limited to, voice, text, file transfer, multimedia, and other like information transfer mechanisms on a network.

“Communication Session” means a period of time whereby a first user and a second user or a plurality of users are in direct contact with each other over a network whereby a communication event can occur between the first user and the second user or plurality of users.

“Chat” means direct and instantaneous one-on-one communication or group communication occurring synchronously or asynchronously.

“Cloak” means to obscure information from the ability to be viewed or to render inconspicuous.

“Cyber Safe Room” means a virtual or physical location where access is achieved with one or more securely authenticated keys for entrance.

“Decloak” means to present information previously obscured from view or rendered inconspicuous as viewable or conspicuous.

“Dual-Phone” means any communications device that allows for more than one network interfaces for communications.

“Electronic Device” means any communication device that allows for the transmission of data from a first user to one or more destinations over a network, including but not limited to a telephones over standard PSTN networks, GSM cellular telephones, PDAs, Voice-over IP (VoIP) devices, dual-phones, desk top computers, traditional radiowave devices, standard display devices, such as televisions, including but not limited to LCD televisions, or other like display devices, or any other electronic device able to send data from a sender to a receiver.

“GSM” (“Global System for Mobile Communication”) means a telecommunications standard for mobile telephones.

“H-323” means protocols to provide audio-visual communication sessions on any packet network.

“Key Time Limit” means a time element, whether a starting time, ending time, or both a starting time and an ending time, during which the key can be used to decrypt encrypted data.

“Memory Device” means components, devices and recording media that retain digital data used for computing.

“Network” means a plurality of electronic devices connected together, whether wired or wireless, for the purpose of sharing data, resources and communication, including, but not limited to, PSTN telephone networks, GSM cellular telephone networks, radiowave networks and computer networks such as, but not limited to, the internet, intranets, LAN, WAN, and other like computer networks.

“Passcode” means a form of secret authentication data that is used to control access to a source.

“PDA” (“Personal Digital Assistant”) means handheld computers having a plurality of features including, but not limited to, some or all of: use as a calculating device, as a clock and calendar, for accessing the internet, as a communication device such as, but not limited to, voice communications and/or for sending and receiving e-mails, for video recording, for typewriting and word processing, use as an address book, for making and writing spreadsheets, use as a radio or stereo, playing computer games, and/or use as a Global Positioning System (GPS) device.

“PSTN” (“Public Switching Telephone Network”) means the network of the world's circuit-switched telephone networks.

“Repository” means the source, library, and/or storage area of a predetermined set of keys to be used in the rotation process of multi-cipher encryption of the communication stream between two users or a plurality of users in a communication session.

“Rotating Keys” means the process of cipher keys being continually exchanged and rotated from a repository of predetermined cipher keys during the course of a communication session. Said process may be initiated manually and/or automatically, with predetermined time cycles, key life spans, and event definitions. The sender and receiver have reciprocal keys in their respective cipher key repositories.

“Security Application” means a computer program stored in memory enabling secure transmission of data from a first user to a second user or a plurality of users.

“Shared Secret” means the confirmation and establishment that at least two keys or sets of keys are the same between the originator (first user) and the recipient (second user) and can thereafter be used in the symmetric key application of encrypting data during a communication session.

“SIP” (“Session Initiation Protocol”) means an application-layer control protocol for creating, modifying, and terminating sessions with one or more participants, including, but not limited to, telephone calls, multimedia distribution, and multimedia conferences.

“Smart Card” means a chip card, or integrated circuit card (ICC), consisting of a pocket-sized card with embedded integrated circuits which can process data.

“Symmetric Key” means a cryptographic algorithm that uses the same key for both encryption and decryption, or uses trivially related keys for encryption and decryption.

“TPM” (“Trusted Platform Module”) means the published specification detailing a microcontroller that can store secured information that offers facilities for secure generation of cryptographic keys, the ability to limit the use of keys as well as a Hardware Random Number Generator, among other functions.

“UICC” (“UMTS Integrated Circuit Card”) means the chip card used in mobile terminals in GSM and UMTS networks, also known as a “smart card.”

“UMTS” (“Universal Mobile Telecommunications System”) means one of the third generation (3G) mobile phone technologies, and is also known as “3GSM”.

“USIM” (“Universal Subscriber Identity Module”) means an application for UMTS mobile telephony running on a UICC smart card which is inserted in a 3G mobile phone.

“VoIP” (“Voice over Internet Protocol”) means the routing of voice conversations over the internet or through any other IP-based network.

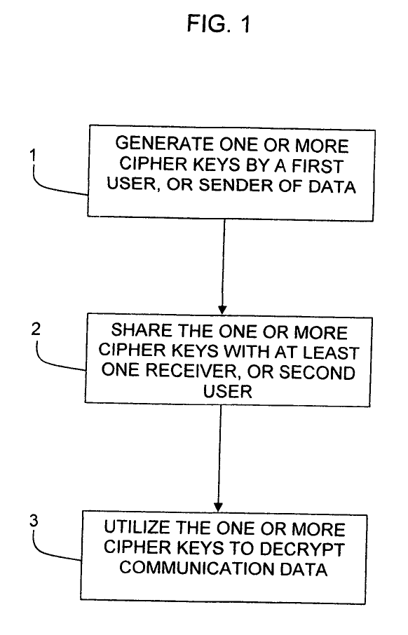

Now referring to the figures, FIG. 1 illustrates a method in an embodiment of the present invention. In a first step (1), one or more cipher keys are generated by a first user, or sender of data. The keys may be created at any time prior to the transmission of the data to one or more receivers of the data. Specifically, the first user authenticates his or her identity via pin code, token, password, biometrics, or other like authentication systems and methods, to receive permission from the security application to generate the one or more cipher keys, each of which is proprietary to that execution and future executions, as described below. The cipher key or keys are preferably symmetric keys, in that the keys may be used to both encrypt and decrypt the data sent from the sender of the data to the receiver of the data. Alternatively, asymmetric keys may be utilized, but this involves sharing of public keys with individuals, and encryption using private keys by the user.

The keys and applications useful for the present invention may be hidden or cloaked on an electronic device, such that hackers or other individuals have no ability to detect the presence thereof. For example, generated keys may be cloaked on the electronic device, and both access and even knowledge of the presence of the keys may be granted only after authentication of the user on the electronic device.

A second step (2) involves the sharing of the one or more cipher keys. Upon creation of the one or more keys, the user may encrypt the one or more keys (i.e. an extensive predefined set of keys), and send the shared one or more keys to a recipient, or second user, such as through e-mail, instant message, or any other communication means. The one or more keys may also be shared in this manner because the one or more keys are preferably in an encrypted form, and may only be decrypted by those with the proper decryption protocol, such as a password or other decryption mechanism apparent to one having ordinary skill in the art. This decryption mechanism is typically received via a separate communication session and operates to authenticate the second user, or it can be sent to a second or plurality of other users on-the-fly in an active or buffered communication session. Alternatively, the transmission of new keys may be completed with or without the users' knowledge or consent.

A third step (3) involves the utilization of the one or more cipher keys to decrypt communication data. The security application or applications, as described herein, allows the first user, i.e., the sender of the one or more keys to determine when, where, to whom, and with what security algorithm the first user will execute in order to encrypt any data chosen through any communication protocol.

In a sending operation, the first user chooses the one or more keys and the option to choose from various encryption algorithms, including, but not limited to, AES, Triple DES, MD5, Blowfish and any other encryption algorithm apparent to one having ordinary skill in the art. This mechanism is utilized to protect the data to a defined recipient. In the receiving operation, the designated recipient must first authenticate himself or herself, the first user having tied authentication of the second user to the one or more keys, thereby allowing for the receipt of the communication via the one or more key, thereby deciphering the communications into a usable application form. Because this involves self-generation of one or more keys, there is no need for a third party, such as a third party server, to be involved in the process. In the decrypting process, applications and other data may become decrypted and/or decloaked, available for an authenticated user to utilize.

It may also be possible for communications to include some form or identification of the key used to encrypt it, so that the receiving device will automatically know which previously received key must be used to decrypt the communication.

The selection of which key is used to encrypt and decrypt a packet of transmitted content may change automatically with or without either users' knowledge or consent.

The receiver will automatically use the required key needed to decrypt the received packet of content, such that the receiver (whether human, computer or otherwise) of the content will continue to receive the decrypted content without interruption.

The embodiments of the present invention relate to security applications that can be either stand-alone applications, such as software, or may consist of hardware devices that are interconnected with, embedded with or otherwise bundled together with an electronic device. Specifically, the stand-alone applications include, but are not limited to, one or more security applications that may be contained on a memory device that may be read by an electronic device for execution of the security applications by the electronic device. The stand-alone application may be interconnected with an electronic device, as defined below. Memory devices utilized in the embodiments of the present invention include, but are not limited to, external hardware device options, such as Mini-USB stick/fob, micro-SD and Mini-SD card (SDIO), or internal memory devices, such as hard drives, or other like internal memory devices.

An electronic device, as used herein, includes any electronic device useful for sending data from at least a sender or a first user to a receiver or a second user. The electronic devices include, but are not limited to, telephones over standard PSTN networks, GSM cellular telephones, PDAs, Voice-over IP (VoIP) devices, dual-phones, desk top computers, traditional radiowave devices, standard display devices, such as televisions, including but not limited to LCD televisions, or other like display devices, or any other electronic device able to send data from a sender to a receiver.

In general, the security applications described in the present embodiments of the invention encrypt and decrypt data during a communication session, be it voice, typed message, data files, dynamically generated data, or multi-media. When a user wishes to securely communicate with one or more receivers, the user, or sender of data, opens a communication session with one or more receivers. The sender sends encrypted data to the one or more receivers in one or more communication events which is decrypted by the receiver or receivers using a key that had been previously disclosed to the receiver or receivers by the sender. The key decrypts the data allowing for utilization of the data by the receiver or receivers. In this sense, although an initial user or sender may open a communication session with an initial receiver or receivers of data, both users of the applications described herein may send and receive data during the communication session.

It is understood that the bilateral communication between electronic devices can result in each user possessing a device that functions as both a user authentication device and a secured device. For example, if secured and authenticated communications between GSM cellular telephones is desired, the first user may have a GSM cellular telephone that functions as a user authentication device with respect to the first user and functions as a secured device with respect to the second user's GSM cellular telephone. Similarly, the second user may have a GSM cellular telephone that functions as a user authentication device with respect to the second user and a secured device with respect to the first user's GSM cellular telephone.

The security applications as embodied herein can be applied in any technology platform allowing for the sending and receiving of data including, but not limited to, forms or versions of Microsoft Windows operating system, forms or versions of Microsoft Windows Mobile operating system, forms or versions of Apple Macintosh operating system, forms or versions of Symbian operating system, forms or versions of Linux operating system, and any other operating systems or platforms, and the invention should not be limited in this regard.

Telephony types utilized in the embodiments of the present invention include, but are not limited to, standard telephonic communications, or networked communications such as, but not limited to, communications over the internet or other like network. Networked communications include, but are not limited to: 1) SIP Peer-to-Peer (two individuals communicating via the Internet or IP Intranet); 2) SIP Conference (multiple individuals communicating via the Internet or IP Intranet); 3) SIP Multicast (broadcast voice message to a group via the Internet or IP Intranet); and 4) SIP to PSTN or GSM UP network interconnected to landline-based or cellular telephones).

Moreover, peer-to-peer VoIP can be utilized and includes, but is not limited to, the following. First, peers can be any combination of SIP clients, such as, but not limited to, SIP softphone on PC, WiFi handheld, Web browser phone, or SIP softphones self-contained on USB, dual-phones, Micro-SD or Mini-SD devices. Moreover, encryption functionality in peer-to-peer VoIP could be all client, all server or a combination of both. Specifically, it is possible for all software to reside on the client device. In addition, clients with limited hardware/software may require a server, or other routing technology apparent to one having ordinary skill in the art, to function as an encryption proxy.

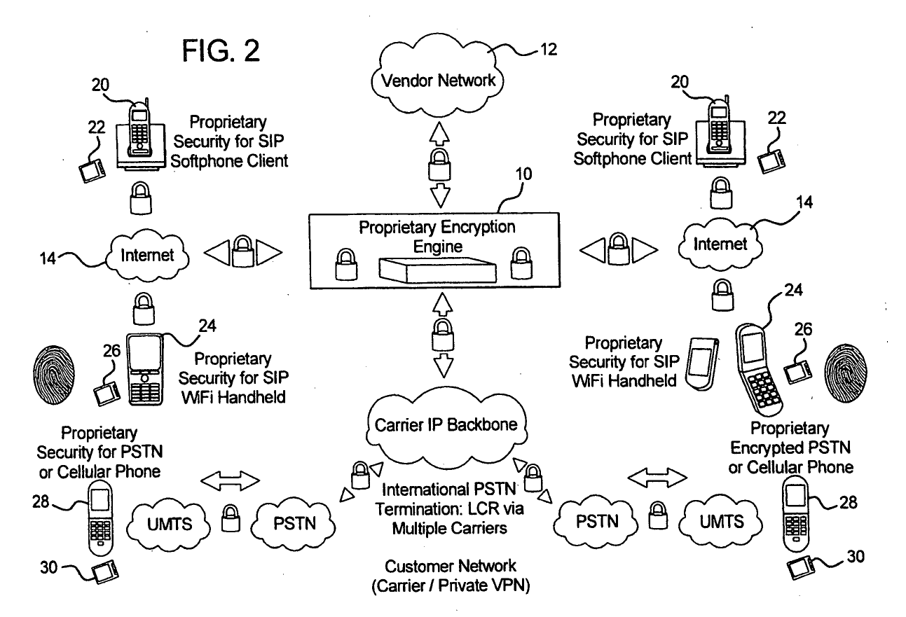

FIG. 2 illustrates a schematic showing the various examples of converging telephony protocols and various encryption applications related thereto. Specifically, FIG. 2 shows an encryption engine 10 of the security application described herein tied, or otherwise associated with various telephony protocols, such as a vendor network 12, the internet 14, and a carrier IP backbone involving international PSTN terminating with LCR (Least Cost Routing) with multiple carriers. More specifically, the internet 14 may be tied to various telephony protocol endpoints, such as SIP softphone client 20 utilizing a UICC card 22, and an SIP WiFi Handheld 24 utilizing a UICC card associated with biometric authentication 26. The carrier IP backbone, described above as, generally, an international PSTN network terminating with LCR via multiple carriers, is tied to telephony protocol endpoints, such as PSTN (conventional landline-based telephony) or cellular telephones 28 associated with a UICC 30 for authentication.

The UICC may further be part of a UMTS network, which is interoperable with other applications programmed into the UICC. The encryption engine 10 enables communication and transfer of credentials to and from the endpoints employing UMTS protocol.

The UICC is used in mobile terminals in GSM and UMTS networks. The UICC ensures the integrity and security of all kinds of personal data, and typically holds a few hundred kilobytes. However, with the advent of more services, the storage space may be larger. New and larger capacities may include mega-SIM cards of 4 GB capacity or more that would be able to utilize the additional memory to deposit executable programs, for example an agent, that may interface with the NOC and execute communication between the flash memory and the EEPROM.

A USIM is an application for UMTS mobile telephony running on a UICC card which is inserted in a 3G mobile telephone. The USIM allows for the storage of user subscriber information, authentication information and provides storage space for text message. Typically, the UICC consists of a CPU, ROM, RAM, EEPROM and I/O circuits.

Providing access to any variation of voice, data, text, video and multimedia services, the USIM will support multiple applications which may include, but are not limited to, e-commerce, e-purse, and e-mail, and even mobile video conferencing using equipment with integrated cameras. The USIM may use JAVA or other software technology integrated with the security architecture of the security applications of the present invention.

For user authentication, one method to be deployed utilizing USIM is to store one or more long-term preshared secret keys, which are shared with the encryption engine in the network. The USIM may vary a sequence number that must be within a range using a window mechanism to avoid replay attacks, and may be in charge of generating session keys to be used in the confidentiality and integrity algorithms of the encryption engine in the server and/or NOC, over, but not limited to, the UMTS network. The communication between the encryption engine on the server and NOC to the endpoints involves a convergence of platforms between GSM, PSTN, and VoIP platforms. To store the protected encryption keys, the endpoints have technology of the present invention together with protected storage mechanisms such as TPM included in many Personal Computer (PC) or non-PC platforms.

Endpoints can also provide identity authentication and attestation, such as via the use of passwords, biometrics, smart chips, etc. These endpoints can include, but are not limited to, SIP softphone on PC, WiFi Handheld, Web Browser Phone, SIP Softphone Self-Contained on USB, Micro-SD, or Mini-SD devices, and other like endpoints.

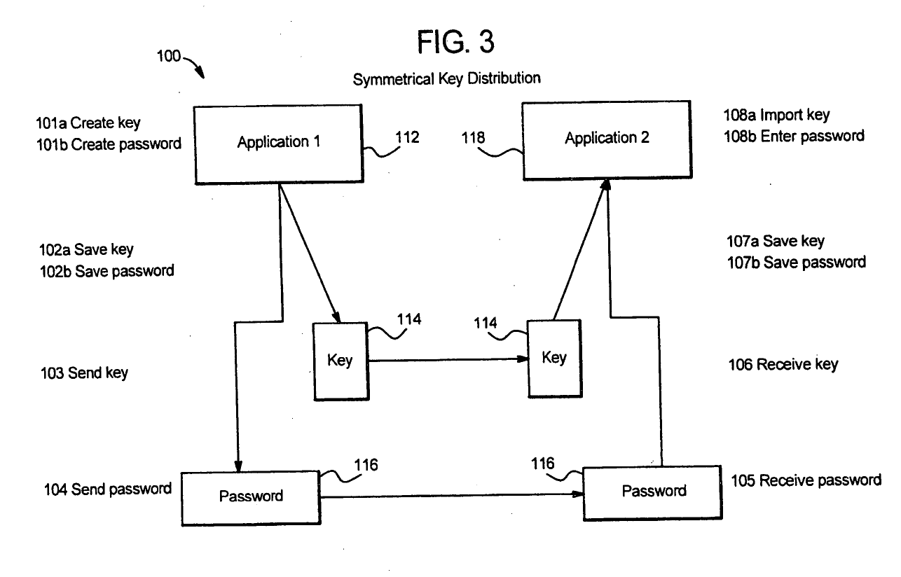

FIG. 3 illustrates a preferred symmetrical key generation, distribution and utilization method 100 in an embodiment of the present invention. Further description of a preferred symmetrical key generation is found in U.S. patent application Ser. No. 11/703,463, filed Feb., 2007 and Ser. No. 11/714,535, filed Mar. 5, 2007, each of which is expressly incorporated by reference herein in its entirety. Although FIG. 3 specifically describes only a first user and a second user, it should be apparent to one having ordinary skill in the art that a plurality of users may utilize the steps contained herein for communication with one or more users.

Specifically, a first user, or sender, at an end-point electronic device, shown as “Application 1” (112) first generates a key 114 using a symmetric key generation protocol via step 101a. A password 116 or other encryption mechanism is created according to step 101b to encrypt the key 114. Both the key 114 and the password 116 are saved by the user, according to steps 102a, 102b. The key 114 is sent to an intended receiver via step 103. The sending of the key 114 may be by any method apparent to one having ordinary skill in the art, including, but not limited to, e-mail, instant messaging, file sharing, SMS/MMS messaging, paging, multi-media, voice mail, direct voice to voice and other like communication methods. The password 116 is further sent to the intended receiver via a communication mechanism separate from the sending of the key 114, according to step 104, including, but not limited to, a separate e-mail, instant message, file transfer mechanism, or other like communication method. The password 116 may further be sent by vocal transmission, video transmission, file transfer, or other standard and low-tech transmission means including, but not limited to, by delivery post, conventional PSTN telephony, or other like methods.

The key 114 and the password 116 are received by the second user, or receiver. Once the receiver of the key 114 and the password 116 are received by the second user via steps 105 and 106, Application 2 (118) may request authentication of the second user, involving the invocation of the password 116 to access the key 114. Specifically, after receiving the key 114 and password 116, the receiver may save the key 114 and the password 116 via steps 107a and 107b. Application 2 (118) can import the key via step 108a, whereupon the password is prompted by the Application 2 (118) to authenticate the receiver. Once the receiver enters the password 116, the key is accessed by the Application 2 (118) and utilized to decrypt data subsequently sent by the first user in one or more communication events during a communication session. As noted above, the communication event may include bilateral communication such that the key 114 may be utilized to encrypt the communication bilaterally between the first user and the second user.

Encryption of data during a communication session may be initiated by the first user, or sender of the data, on the endpoint electronic device, which may be enabled by the first user, or sender, from an Option Menu or button on the endpoint electronic device, and may be part of the endpoint device setup/configuration. Specifically, a communication session may be opened by the first user with the second user, whereupon the first user may engage the second user in a communication event, such as a telephonic communication. After receipt of the one or more cipher keys from the first user, the first user may engage the encryption of the communication event by pressing a button or otherwise turning the encryption “on.” This may be done at any point during the communication session, such as before the communication event commences, or part-way through a communication event, whereupon some, but not all, data transmitted by the user is encrypted. This may occur during a particularly sensitive part of the communication event. Therefore, the user has the option of carrying out the communication event unencrypted or encrypted at any point during the communication event.

Additionally, the one or more keys generated by the first user may rotate during a communication session. For example, a communication session may commence, and a communication event may occur, such as, but not limited to, a telephonic communication between the first user and the second user, whereupon the first user applies the encryption of the data by turning the encryption “on.” At some pre-defined point during the communication event, the cipher key may rotate to another previously generated and shared cipher key, stored in a repository of predefined cipher keys. The rotation may occur at predefined moments, such that both the first user and the second user may have respective cipher keys rotated, sourced from their respective cipher key repository, (i.e., so that the first user may encrypt using the same key as the second user uses to decrypt, and vice versa). Rotation of the keys during a communication session for a communication event may occur, for example, at predetermined times, or at predetermined events, such as after a predetermined amount of data is transmitted during a communication event. Alternatively, the rotation of the keys may occur at any time during the communication session when the originator or initiator (first user) of the communication session informs or otherwise initiates a change in the key used to encrypt and decrypt. The rotation of the keys initiated by the originator or initiator (first user) of the communication session may occur at predetermined or predefined times, or randomly during the communication session.

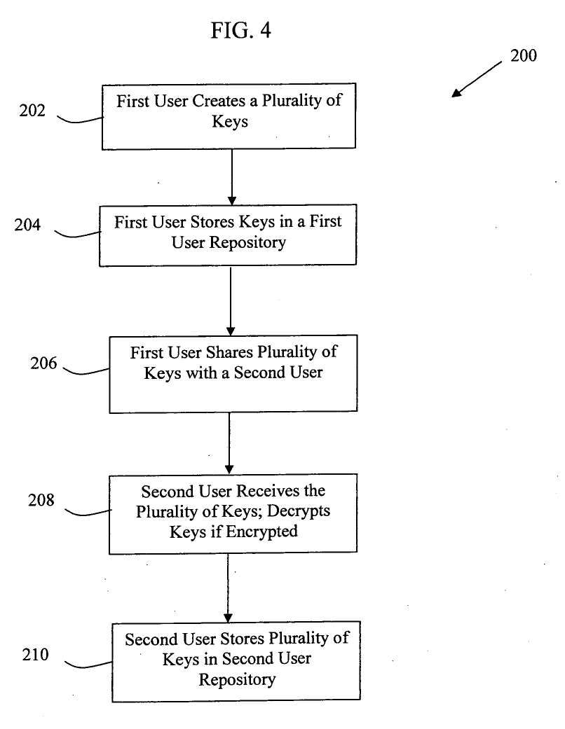

For example, FIG. 4 illustrates a method 200 of creating and sharing a plurality of keys between a first user and a second user for use in a communication session. In a first step 202, a first user creates a plurality of keys for use in a future communication event between a first user and a second user. In a second step 204, the first user stores the plurality of keys in a first user repository. In a subsequent step 206, the first user shares the plurality of keys with a second user, or a plurality of other users the first user wishes to have a communication session with using a communication device. The plurality of keys may be sent in one communication event, such as in an email, during a chat, or may be physically sent to the second user or other users, such as on a flash drive or other like storage device, for additional security. Moreover, the plurality of keys may be encrypted by the first user for decryption by the second user or other users. In a subsequent step 208, the second user receives the plurality of keys. If encrypted, the second user decrypts the plurality of keys. In a subsequent step 210, the second user stores the plurality of keys in a second user repository. The first user repository may be interconnected with a first user communication device or application. The second user repository may be interconnected with a second user communication device or application. The plurality of keys, or at least a particular set of keys, therefore, may be identical between the first user and the second user, and is available during a communication session between the first user and the second user.

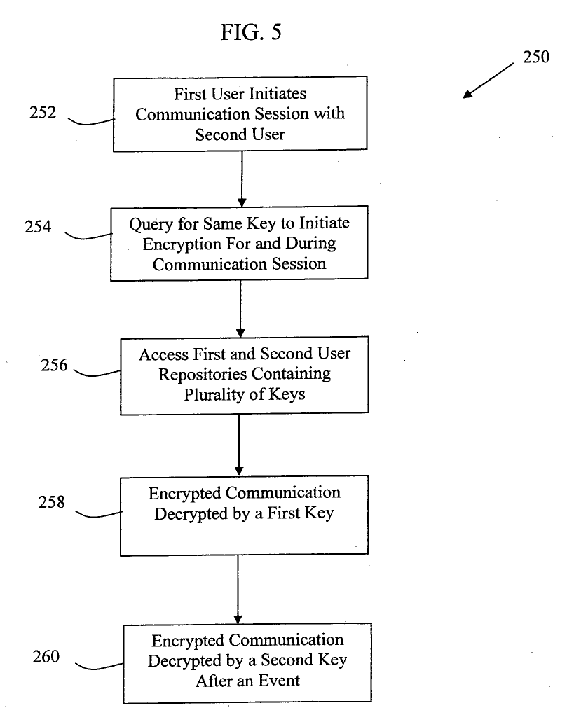

FIG. 5 illustrates a method 250 of a communication session illustrating the automatic rotation of the plurality of keys shared between the first user and the second user, as demonstrated in FIG. 4, above. Specifically, in a first step 252, the first user initiates a communication session between the first user and the second user. The communication session may be any electronic communication between the first user and the second user whereby at least one communication event can occur between the first user and the second user, as defined above. Of course, the communication session may be between a first user and a plurality of other users in a group communication session, whereby each of the users in the group communication session has the plurality of keys in each user's repository for use during the communication session.

In a second step 254, either the first user or the second user may initiate encryption during the communication session. As noted above, the encryption can occur at any time during the communication session. Specifically, initiation of the encryption of the communication may occur when the first user queries the second user for the same key for the communication. Moreover, the first user may continue to query the second user for additional keys during the communication session. More specifically, encrypted communication may be established prior or coincident with the sending of the name of the key and a, for example, a hash code, which is a unique identifier, sent from the originator or initiator (fir user) to the recipient (second user) asking if said key is available in recipient's repository. If the same key exists in the recipient's repository, then the response is affirmative, and a Shared Secret is established. Conversely, if there is no such key in the recipient's repository, the response is negative and the action is denied. This process is the “Challenge Response Communiqué,” which is a challenge response mechanism enabling the originator to prep the receiver that the originator or initiator (first user) is looking to use, for example, key name “ABC.” If after confirmation that the same key does exist in recipient's repository, then the receiver is then ready to know what key to pull from its repository, establishing the Shared Secret to be used for encrypting the communication session itself—in this case, key “ABC.” This process is the same for one or a plurality of keys. For example, the Challenge Response Communiqué may provide a challenge response mechanism to determine whether the originator and recipient have a single key that is the same, or a plurality of keys or a specific set of keys that is the same prior to or coincident with the communications session. The Challenge Response Communiqué may occur each time a key rotation occurs throughout the communication session, as dictated by the originator or initiator of the communication session. Alternatively, a plurality of keys or a specific set of keys may be used in key rotation at predetermine or predefined times during the communication session.

In a subsequent step 256, the first and second users access their respective repositories containing the plurality of keys. In a subsequent step 258, the encrypted communication session is decrypted by a first key from the plurality of keys in each of the first and second users' repositories. By necessity, the first key for encrypting the communication session and decrypting the communication session is the same between the first user and the second user so that the first user and the second user can share the communication.

In a subsequent step 260, a second key is utilized for both encrypting and decrypting the communication session between the first user and the second user. The second key may be automatically selected after a certain period of time has passed or after a certain event, such as a volume of data has been sent and/or received by the first user and the second user. At this time, the first key may no longer be usable to encrypt and decrypt the communication session. Preferably, the second key is automatically selected after a predetermined amount of time has passed in the communication session, whether sub-second, second, sub-minute, minute, sub-hourly, hourly, sub-daily, daily, sub-weekly, weekly, or other like time period. In a subsequent step 262, a third key is automatically selected after the time period of event has elapsed to trigger the selection of the third key. In subsequent steps, not illustrated in FIG. 5, many if not each of the keys in the repositories of the first and second users may be utilized to encrypt and decrypt the communication between the first user and the second user.

The selection of the keys from the first and second users' repositories may be done automatically based upon some predetermined algorithm that is shared between the first and second user. Alternatively, the first and second user may specifically designate the order of the keys, between themselves, in a separate communication event, and may designate the time period or event to trigger the rotation of the keys. For example, the first and second users may agree to rotate the keys after a time period that is sub-second so that the communication session has a constant rotation of the keys during the communication session. The keys may be selected based on some predetermined criteria, such as in the order received from the first user to the second user, numerically or alphabetically in order, or some other predetermined algorithm between the first user and the second user.

Alternatively, the timing of the key rotation and the selection of the particular keys during the rotation may be done manually at various points during a communication session, with the rotation and key being communicated between the first user and the second user in some manner, such as via a separate communication event, such as a separate email, chat, or other communication. Preferably, however, the time of rotation and selection of subsequent keys are automatic during the communication session. If done precisely, neither the first user nor the second user may have any knowledge that the key rotation has occurred, since the rotation may be seamless.

The rotation of keys during the communication session between the first user and the second user adds heightened security to the communication session. Of course, the rotation of keys, as noted above, may occur between more than two users in group communication session, as long as each user in the communication session utilizes the same key at the same time during the communication session.

Moreover, although the present invention describes the generation of the plurality of keys and sharing thereof (as described in FIG. 4) occurring before a communication session between a first user and a second user or more users, the generation of the plurality of keys and the sharing thereof may occur at the same time as the communication session in a separate communication event, such as communication via a separate email between the first and second users, chat, or some other communication event shared between the first and second user.

Improper usage of keys and/or predetermined time period or event may trigger an alarm alerting the other user or users in the communication session that a user is attempting to obtain access to the communication session utilizes the improper keys and rotation.

Alternatively, one or more cipher keys may be utilized to encrypt more than one communication event during a communication session. For example, when a communication session involving a telephonic communication that constitutes a first communication event commences, a file may also be transferred to the second user from the first user, which constitutes a second communication event during the communication session, and/or a third (or more) communication event may occur during the communication session. Both the first communication event and the second communication event (or more) may be encrypted using the same shared key. Alternatively, the first communication event and the second communication event (or more) may be encrypted using different keys or some combination of the same key and different keys.

Moreover, an electronic device may have a “chat” feature, such that the presence of a user may be noted as being “present” on a network and the users may engage in a chat communication event, typically using text message or instant messaging. For example, if the communication session occurs over the internet, the first user may receive notification that the second user is also present or logged onto the internet and using his or her electronic device used for communications. In a preferred embodiment of the present invention, a communication session is opened between the first user and the second user only when both the sender and the receiver are both present on the network at the same time. This provides for true and secure peer-to-peer communication between a first user and a second user.

Further, secure communications between multiple users may be accomplished with the systems and methods of the present invention. Specifically, a user may engage a plurality of receivers by sending one or more encrypted keys, as described above, to a plurality of receivers. The user may initiate a communication session with the multiple receivers, including, but not limited to, telephone conference calls, video conferencing, or other like communication events. By decrypting the one or more keys, the plurality of receivers may engage in the communication event together during the same communication session, for example, in a cyber safe room.

Typically, keys that are generated according to the present invention are usable for a single communication event. However, keys may also be designated as having no expiration, such that a specific key can be designated to be used over and over again. Alternatively, keys utilized for encrypting and decrypting the data transmitted may have a key time limit such that the key is only active during a specific, predefined timeframe. The starting time, the ending time or both the starting time and the ending time may be designated by the sender. The key time limit allows a key to remain and/or become inactive at specific, predefined times. For example, a key may be generated for the transmission of data relating to a file transfer from a first user to a second user. If the second user fails to authenticate him or herself and/or decrypt the key, and apply said key to said encrypted data relating to the file transfer after a predetermined amount of time, then the key will expire, and the receiver will be unable to decrypt the encrypted data using that key. Alternatively, encrypted files may have self-destruct features, such that if a file is not decrypted within a predetermined amount of time, then the file will self-destruct, rendering the file unusable, or the file will erase itself.

Visual encryption may be applied for a communication session, in that some type of confirmation may be utilized to confirm that the call is encrypted. Specifically, the electronic device may include an icon on a display indicating whether encryption is engaged or disengaged.

In a further embodiment of the present invention, communications may be secured by integrating or concatenating multiple networks together into a single communication stream. The single communication stream may be enhanced by having heightened security, such as through multi-factor authentication, multiple encryption algorithms, and manual and/or automatic initiation of multiple rotating keys for the encryption algorithms. For example, multi-factor authentication may include authenticating users based on at least two or more of the following: fingerprint recognition, facial recognition, iris recognition, voice pattern recognition, PIN code, IMEI code, geo-positioning vector input, cipher application, pre-allocated alphanumeric code and/or server-to-device challenge response. Of course, any authentication method may be utilized as apparent to one having ordinary skill in the art. Encryption algorithms may include, but are not limited, at least two or more of the following: DES, Triple DES, Blowfish and/or Rijndael (AES 128 and 256). Of course, any encryption method may be utilized as apparent to one having ordinary skill in the art.

### EXAMPLES

The following examples describe embodiments and specific implementations of the above-described security applications of the present invention. The standards and protocols described herein are examples, and are not limited as described herein. Further description of embodiments of the present invention are described in U.S. patent application Ser. No. 11/703,463, filed Feb. 7, 2007 and Ser. No. 11/714,535, filed Mar. 5, 2007, each of which is hereby incorporated by reference in its entirety.

### Example 1

Method 1: Method 1 of Example 1 utilizes the SIP protocol, in which signaling traffic is encrypted using, but not limited to, Synchronous Authentication, Transport Layer Security (TLS) or Secure/Multipurpose Internet Mail Extensions (S/MIME). All network traffic may be further encrypted using, for example, IPSEC Encapsulating Security Payload (SSP). Media traffic is encrypted using, for example, symmetrical key distribution, all of which the encryption engine implements for the purpose of securing data traffic at end points, during transmission, through the server/NOC or independently at a peer-to-peer level.

Method 2: Method 2 of Example 1 also utilizes the SIP protocol, in which the user also has the ability to independently encrypt data of choice. If the user utilizes a dual-phone phone, that user will be able to communicate using the encryption engine via the server and NOC levels. In this case, the security application processes are managed and distributed at the server and the NOC. In this user scenario, no UICC card or chip is required to independently communicate with the server and NOC for security applications to be executed.

When in a VoIP network, each VoIP phone has an IP address and identity. As such, direct sending and receiving of security credentials are processed at the UICC level, separately and independently from the server and NOC applications. In this user scenario, the UICC is required and employed because the programming, security credentials and CPU operation are conducted at the endpoint level.

As an initial step for protection of data contained within the end-point devices, the user generates a key associated with a pin, biometric or other like authentication means. Once completed, the security and communication technology have the ability to hide or cloak the user information, such as the encryption key, data, and other like information, at the end-point device when not in use by the user. This may be done manually or automatically.

Also, as an initial step for the protection of data and communications, the user may generate specific, topic or community oriented keys that are associated with the key that is associated with the pin, biometric or other like authentication means. These keys may be shared with the specific community or business colleagues whom the user wishes to communicate with in all manners utilizing the encryption, capabilities of the present invention. The shared colleague may be required to associate the keys with their authentication association on their end-point device, thereby allowing security communications between the original user and the shared colleague. If more colleagues are required to communicate via this method, the original user may distribute keys as needed to these colleagues.

In a sending operation the user chooses a key and the option to choose from various encryption algorithms, including, but not limited to, AES, Triple DES, MD5, and Blowfish, for example. This mechanism may then be utilized to protect the data to a designated recipient.

In a receiving operation, the designated recipient first authenticates him or herself, the sender having tied authentication to the keys, and allows for the receipt of communications via the keys, thereby deciphering the communications into a usable application form. Because this constitutes self-generation of keys, there is no need for a third party, such as a third-party server, to be involved in the process.

One specific embodiment provides for the authenticated and encrypted storage of personal records, such as, for example, personal medical records, films, scans of all multi-media formats, on an electronic device in memory, such as on a flash drive, hard drive, PC, laptop, television that has memory built in, or other like memory devices, or on servers associated or otherwise linked to electronic devices. The electronic device maintains a private, hidden area of memory bundled with the security applications of the present invention for the express purpose of storing personal health records. Once authenticated, the electronic device can serve as the default storage device of an individual, allowing them a complete copy of their personal records in a secure electronic device. If lost, authentication is required not only to gain access to the records, but to even have knowledge of the presence of the records, thereby limiting attack by hackers and the like. The electronic device, as described herein and utilizing the security applications described herein, can be utilized for the transmission of the personal health records to physician's offices, medical laboratories, and hospital facilities, for example. In addition to personal health records, payment capabilities of storing value, such as, but not limited to, credit cards, bank records, etc., can allow for the use of the electronic device for payments, scheduling and communication.

Another embodiment could be a financial executive, healthcare physician, insurance executive, or government official using a USB-based user security application, as described herein, to connect a secure electronic device to a personal computer via USB ports in order to execute encrypted communication through a security application, as described herein. For example, an investment banker may wish to talk to and send data to a very high profile client that demands absolute privacy. This may be undertaken by encrypting the transmission of the data to form encrypted data, then creating an encryption key associated with that encrypted data, sent via an encryption communication pathway by way of a chat box embedded in a secured softphone that resides and is executed from the electronic device. The investment banker not only sends encrypted data, but does so in encrypted communication as he or she is speaking to the client, said oral communication also encrypted. Moreover, if the banker and his or her client wish to see each other via video conference, the encryption key may be used to create a secured video session.

Method 3: A first user and a second user (or more) are engaged in a communication session, whereby multiple communication events occur during the communication session. Specifically, the communication session includes a communication event relating to the transmission of a voice communication between the first user and the second user. This communication event utilizes a first key for decryption thereof. During the voice communication, a second communication event (chat) may be initiated between the first user and the second user. This communication event utilizes a second key for decryption thereof. Still further, a third communication event (file transfer) between the first user and the second user may occur. This communication event utilizes a third key for decryption thereof. Finally, a fourth communication event (a second chat) occurs during the communication session (but not at the same time as the first chat). This fourth communication event utilizes a fourth key for decryption thereof.

### Example 2

With the initialization complete, credentials utilized to protect the data of the phone itself and requiring authentication of the user may be utilized as a payment vehicle for any commerce conducted through the connected network.

Method 1: The user subscribes to a service which provides him or her with update prospects, market information, or any other service. As a login and authentication process, the user utilizes the authentication solution in the security application as the authentication for the login. This same process is used during the procurement process for the service itself, and may also be utilized for any purchase into an up-sell or cross-sell offer available on the network.

Method 2: The user purchases an item at a mall, grocery store, gas station, or any physical store offering a good or service. The user utilizes his or her endpoint device for the purpose of paying for the good or service. This is completed by running a payments application on the endpoint device. Authentication occurs via the authentication process in the security and communications technology platform, and the transaction is recorded in the payments application.

In each of the examples noted above, encryption and decryption of data during the one or more communication sessions described may be done using automatic or manual rotation of keys that are stored within repositories at each user's device and/or application.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A method of communicating between a first user and a second user comprising the steps of:
providing a first user and a second user, the first user and the second user participating in a communication session with each other involving the transmission of data between the first user and the second user, the first user having a first repository having a plurality of keys contained therein, and the second user having a second repository having a plurality of keys contained therein, wherein at least some of the keys in the first repository and the second repository are the same;
initiating an encryption of the data between the first user and the second user during the communication session;
decrypting the data using a first key, wherein the first key is contained within the first repository and the second repository and the first user and the second user utilize the first key to decrypt the data; and
decrypting the data using a second key after an event occurs during the communication session, wherein the second key is contained within the first repository and the second repository.

2. The method of claim 1 wherein the event is the end of a time period.

3. The method of claim 1 wherein the event is transmission of an amount of data.

4. The method of claim 1 wherein the utilization of the second key to decrypt the data occurs automatically after the event has occurred.

5. The method of claim 1 further comprising the steps of:
prior to decrypting the data using the first key, sending a name of the first key from the first user to the second user;
querying the second user if the first key is available in the second repository; and
proceeding with decrypting the data using the first key if the first key exists in the second repository.

6. The method of claim 1 further comprising the step of:
decrypting the data using a third key after a subsequent event occurs during the communication session, wherein the third key is contained within the first repository and the second repository.

7. A method of communicating between a first user and a second user, comprising the steps of:
providing a communication session between a first user and a second user involving the transmission of encrypted data;
decrypting the data at a first time using a first key and decrypting the data at a second time using a second key.

8. The method of claim 7 wherein the first key and the second key are shared between the first user and the second user.

9. The method of claim 7 wherein the first user has a first repository and wherein the first and second keys are stored within the first repository.

10. The method of claim 7 wherein the first user has a first repository wherein the first and second keys are stored within the first repository and the second user has a second repository wherein the first and second keys are stored within the second repository.

11. The method of claim 7 wherein the first user communicates with the second user with a communication application, and further wherein the first user has a first repository wherein the first and second keys are stored within the first repository, and further wherein the first repository is interconnected with the communication application.

12. The method of claim 7 further comprising the step of:
decrypting the data using different keys after events have occurred during the communication session.

13. The method of claim 12 wherein the decryption of the data occurs after an amount of time has elapsed.

14. The method of claim 12 wherein the decryption of the communication session occurs after an amount of data has been transmitted between the first user and the second user.

15. The method of claim 7 further comprising the steps of:
providing the communication session between the first user, the second user and a third user, wherein the first user, the second user and the third user have a plurality of the same keys for decrypting the communication session through a process of automatically rotating the keys.

16. A system for facilitating a secure communication between a first user and a second user comprising:
a first user having a communication application for communicating with a second user;
a first repository associated with the first user's communication application for storing a plurality of keys;
a second user having the communication application for communicating with the first user; and
a second repository associated with the second user's communication application for storing the plurality of keys.

17. The system of claim 16 further comprising:
a communication session between the first user and the second user, wherein the communication session involves the transmission of encrypted data between the first user and the second user;
a first key for decrypting the data between the first user and the second user, wherein the first key is stored within the first repository and the second repository; and
a second key for decrypting the data between the first user and the second user, wherein the second key is stored within the first repository and the second repository, wherein the first key decrypts the data at a first time and the second key decrypts the data at a second time.

18. The system of claim 16 further comprising:
a communication session between the first user and the second user, wherein the communication session involves the transmission of encrypted data between the first user and the second user;
a first key for decrypting the data between the first user and the second user; and
a second key for decrypting the data between the first user and the second user, wherein the first key decrypts the data at a first time and the second key decrypts the data after an event has occurred during the communication session.

19. The system of claim 18 wherein the event is the end of a time period.

20. The system of claim 18 wherein the event is a transmission of an amount of data.
